(19) United States
(12) Patent Application Publication
(10) Pub. No.: US 2004/0051269 A1
(43) Pub. Date: Mar. 18, 2004

(54) Four wheel drive stationary body vehicle with controlled wheel and passenger compartment lean, with independent steering

(76) Inventor: Todd Richard Bouton, Janesville, WI (US)

Correspondence Address: TODD RICHARD BOUTON, 3742 BRAEMORE DR., JANESVILLE, WI, 53545, US

(21) Appl. No.: 10/244,834

(22) Filed: Sep. 17, 2002

(51) Int. Cl. B62D 9/02

(52) U.S. Cl. 280/124.103

(57) ABSTRACT

In this vehicular chassis system, the vehicles passenger compartment and wheels incline toward the turning center side. In such a manner, that the wheels can be tilted independently from steering the vehicle, while maintaining the body of the vehicle level to the ground. With a steering apparatus controlling the steering, and a separate apparatus controlling the tilting, tied in with a rack and pinion and moving left and right with a transversely moveable cross member.

The person in this vehicle has the option to lean in a turn or on a hill, whether the lean is controlled with a mechanism, or manually assisted with recoil springs. The passenger compartment rotates the pinion gear, which moves the transverse cross member (rack). Then in turn, tilts the tires in the leaning direction. Making it a much more natural turn or easier hillside for the vehicle to transverse.

### BACKGROUND OF THE INVENTION

The present invention relates generally to systems for driving, steering, and leaning a three or four wheel vehicle. Prior art shows that inventions that lean all four wheels have a direct connection to the steering wheel and or leaning apparatus. My invention has an independent steering apparatus (steering wheel or handlebars). My invention has an independent leaning apparatus with a weight transfer on a passenger compartment or a mechanically assisted lean, in the turn or on a hill.

My invention shows the ability to drive all four wheels in the most extreme leaning situations (sharp turns or steep hillsides). Other inventions show a limited leaning capability with no obvious telescopic drive shaft to drive any of the four wheels mounted on the tilt suspension. And that would explain why some of the inventions went to three wheels.

Driving a leaning vehicle with three wheels would be easily accomplished with a single wheel in the back or front, like a motor cycle.

My invention shows all four wheels being driven with a telescopic drive shaft, combined with a dog bone for clearance with little or no limitations to its max tilting ability. Some inventions have tilting bodies which gives the passengers the feel of a motor cycle in a turn, which puts them in a deceiving situation, the stationary upright tires are in a unnatural position in a turn so instead of sliding, these vehicles would have a tendency to flip.

All leaning vehicles in a fast turn can experience what's known in the motor cycle racing world as a high side. Where the leaning vehicle starts to slide in the turn and abruptly stops sliding, which whips the person in the opposite direction of the turn.

On my invention if there were tires sliding in the leaned turn, a driver could push a button mounted on the steering wheel or handle bar that would engage a pinion locking device (mechanical lock) mounted on the frame to lock the tilted vehicle in place. And maintain complete control of the vehicle in the turn with the independent steering apparatus.

My invention has a frame on the suspension that maintains level to the ground, independent from the passenger compartment tilt and wheel tilt. Which allows a vehicles body to be mounted on the frame or level to the central plane, which also means no tilting body. So the body can have a lower profile, meaning a safer turn and a-lot less top heavy for transversing a hillside.

A manual search of the following classes and subclasses of art was conducted:

Class 280 (Land Vehicles); Subclasses 112.2 1124 103, 124. 107, 93. 51.

An examiner in Washington, D.C. was consulted to confirm that the appropriate classes of art had been identified.

The following prior art, all of which are US patents, were noted as being most relevant:

U.S. Pat. No. 4,650,213 U.S. Pat. No. 4,632,413 U.S. Pat. No. 4,624,469 U.S. Pat. No. 4,600,216 U.S. Pat. 4,159,128

U.S. Pat. No. 2,961,254 U.S. Pat. No. 2,819,093 U.S. Pat. No. 980,508

### BRIEF SUMMARY AND OBJECT OF THE INVENTION

The invention seeks to realize among other things the following:

The object of the invention is to provide a novel driving mechanism that combines driving capabilities with tilting capabilities in a turn, or transversing hill.

A principle object of the present invention is to have several designs to limit its tilt for safety purpose or increase the tilt for maximum capability. A change of component and assembly part sizes, and its capable of a driving a lean angle of 50+ degrees from the central plane.

A further important object of the present invention is to provide a steering mechanism that is independent of the tilting mechanism.

Another major object of the invention is to provide a tilting mechanism that is controlled by the transfer of weight about various points on a pivot shaft, a passenger compartment tilting in response to the transfer of weight. May be balanced to level with recoil springs. Another principle object is to provide a tilting mechanism that leans the passenger compartment with a machine, known in the art as hydraulics, DC gear motor, or a simple power steering pump.

Yet another object of the present invention is to provide a high performance vehicle that allows safer turns at higher speeds due to an increased turning capability thereof the tilting passenger compartment and wheels.

Still another object of the present invention is to provide a body and frame that stays level with the central plane while the passenger compartment and wheels lean into a turn or tilt on a hill.

It is a further object of the invention to provide a tilt wheel and passenger compartment capability for off road vehicles, construction equipment, moon rover vehicles, or mowing machines.

These and other objects and advantages of the invention will become more fully apparent from the description of the views and the detailed embodiments that follow, or may be learned by the practice of the invention.

### BRIEF DESCRIPTION OF THE DRAWINGS

FIG. 1: Is a front view with the vehicle driving straightforward. This suspension used in a four-wheel drive mowing machine that must transverse a hillside.

FIG. 2: Is a front view, with the vehicle driving straightforward. The suspension in a two or four-wheel drive stationary car body, with a motor cycle passenger compartment in a normal up right position.

FIG. 3: Is a front view of this same suspension, but with the motor cycle passenger compartment and wheels in a tilt position when turning left.

FIG. 4: Is a 3D view, front, top, and right side. Showing both suspensions in use on a four-wheel drive vehicle, tilting into a left turn.

FIG. 5: Is a 3D view, front, top, and left side. The right half of the suspension mostly assembled, the left half mostly unassembled, to show the construction and the components.

FIG. 6: Is a 3D view, front, top, and right side, driving straightforward. This is a four-wheel drive stationary car body, with a motor cycle passenger compartment, in a normal up right position driving straightforward.

FIG. 7: Is a 3D view, front, top, and left side. Showing both suspensions in conjunction with each other transversing a hillside.

FIG. 8: Is a 3D view, front, top, and right side of vehicle tilting left into turn.

FIG. 9: Is a 3D view, front, top, and left side of vehicle tilting right into turn.

FIG. 10: Is a 3D view, front, top, and right side of vehicle steering right into turn.

FIG. 11: Is a 3D view, front, top, and right side view of vehicle steering left into turn.

### DETAILED DESCRIPTION OF THE EMBODIMENTS

These embodiments referring now to the accompanying drawings, FIG. 5 will be on a vehicular chasses system 10 that includes a frame 12 defining a longitudinally oriented central plane 14 and left and right lower control arm attachment points 16, 18 at fixed transverse distances from the central plane 14. And a transversely movable cross member 54 operably attached to the frame 12, with the respected cross member 54 having at opposite transverse ends thereof left and right upper control arms attachment points 22, 24

A left suspension assembly 78 includes a left lower control arm 26 and a left upper control arm 28 attached at an inner end thereof respectively in an articulated fashion to the left lower control arm attachment point 16 of the frame 12, and the left upper control arm attachment point 22 of the cross member 54. The outer ends of the left lower and upper control arms 26,28 are attached to the left upper and lower knuckles 60,62. The respective knuckles have fixed mounts with the left upper and lower steering cylinders 32,66. A left steering shaft 36 vertically mounted on pivots, respectively to the left upper and lower steering cylinders. A left steering knuckle joint 30 having a fixed mount to the upper end of the respective left steering shaft.

The respective upper left steering knuckle 60 has one separate attachment point 110 for an upper tie rod 114, pivotally mounted to keep them in a fixed position to maintain a fixed distance with the left steering knuckle joint 30, and the left steering wheel knuckle joint 120, to maintain left steering rod 116 alignment.

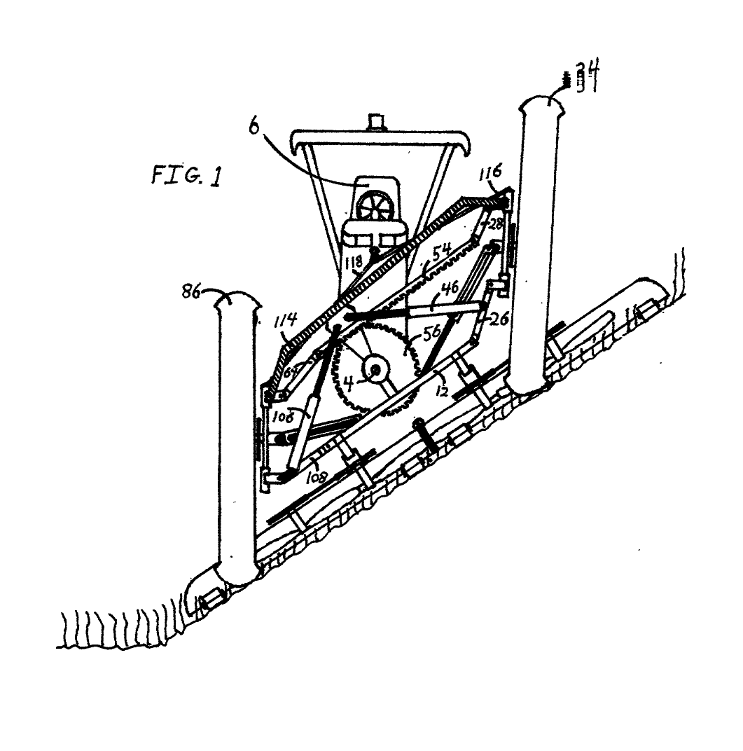

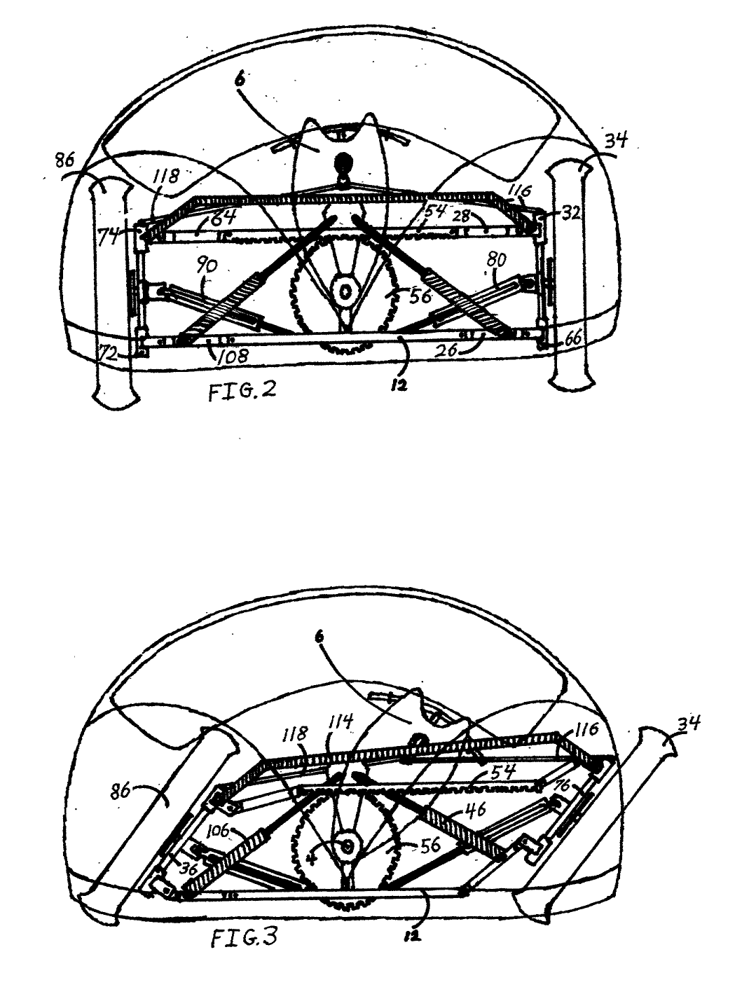

FIG. 1 A left wheel 34 is rotatively mounted on a left axel 40 (shown in FIG. 5)

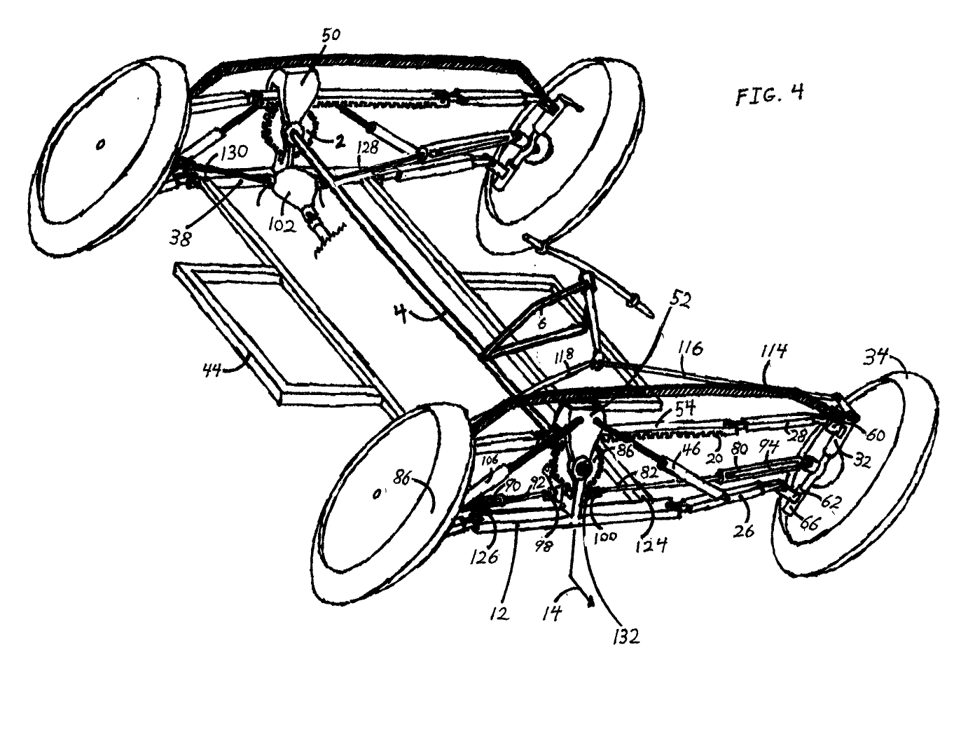

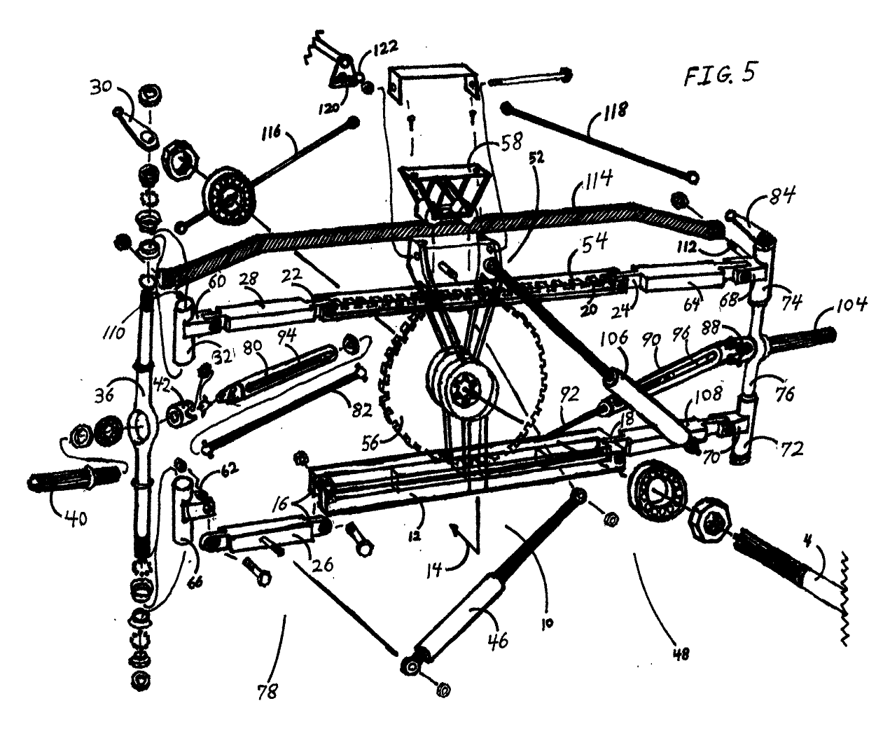

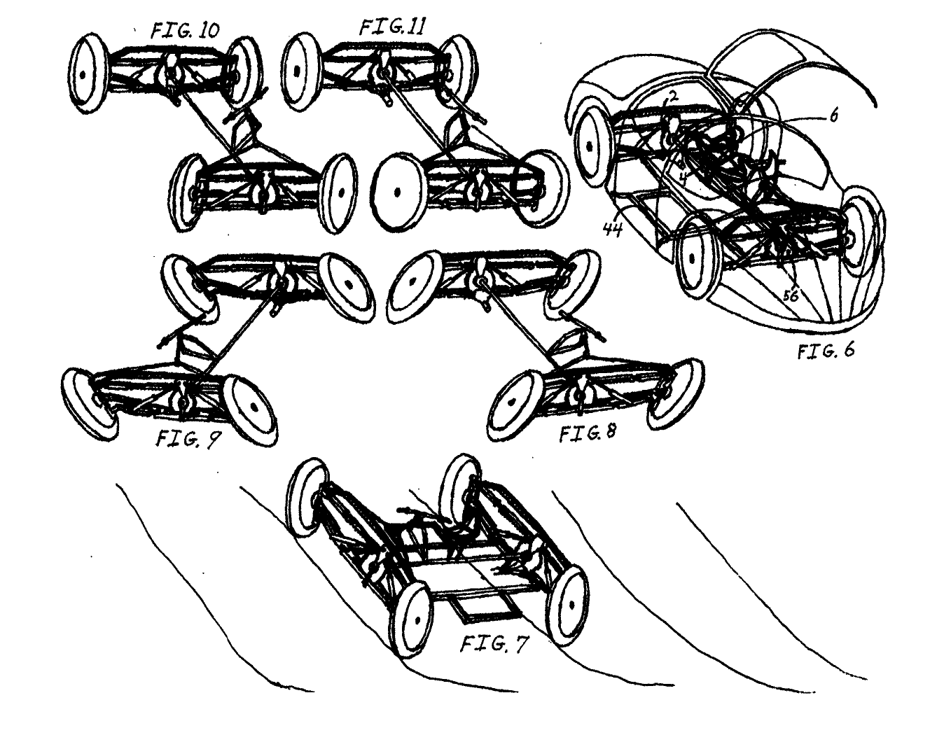

The respective left axel 40 has an attachment point 42 to a left universal joint drive shaft 80. The left drive shaft respectively is telescopically connected and rotatively attached with guide slots 94 to the left dog bone shaft 82, universally mounted 100 (shown in FIG. 4) to the left side of the rear end 132, to drive the vehicle.

A left strut assembly 46 (shown in FIG. 5) is operably attached between the left lower control arm 26 and the frame 12.

A right suspension assembly 48 includes a right lower control arm 108 and a right upper control arm 64 attached at an inner end thereof respectively in an articulated fashion to the right lower control arm attachment point 18 of the frame 12, and the right upper control arm attachment point 24 of the cross member 54. The outer ends of the right upper and lower control arms 64,108, are attached to the right upper and lower knuckles 68,70, respective knuckles have fixed mounts with the right upper and lower steering cylinders 74,72. A right steering shaft 76 vertically mounted on pivots, respectively to the right upper and lower steering cylinders. A right steering knuckle joint 84 having a fixed mount to the upper end of the respective right steering shaft.

The respective upper right steering knuckle 68 has one separate attachment point 112 for an upper tie rod 114, pivotally mounted to keep them in a fixed position to maintain a fixed distance with the right steering knuckle joint 84, and the right steering wheel knuckle joint 122, to maintain right steering rod 118 alignment.

A right wheel 86 (shown in FIG. 1) is rotatively mounted on a right axel 104 (shown in FIG. 5)

The respective right axel 104 has an attachment point 88 to a right universal joint drive shaft 90. The right drive shaft respectively is telescopically connected and rotatively attached with guide slots 96 to the right dog bone shaft 92, universally mounted 98 (shown in FIG. 4) to the right side of the rear end 132, to drive the vehicle.

A right strut assembly 106 (shown in FIG. 5) is operably attached between the right lower control arm 108 and the frame 12.

Although the upper and lower control arms are shown as simple beams in FIG. 5 for the sake of illustration, they could also be configured as A-frames having dual upper and lower attachment points to provide additional fore and aft stability to the suspension assemblies. The chasses and suspension system may also include other struts, stabilizer bars, and drive or steering components, of a type commonly known in the art.

Cross member positioning means 52 in the form of a rack 20 defined by the transversely moveable cross member 54; a pinion 56 mounted on the suspension frame 12 in a gear mesh relationship with the respective rack 20; and a guide 58 attached to the respective suspension frame 12; are provided for positioning the cross member 54 transversely with respect to the central plane 14.

By turning the pinion 56, the rack 20 drives the cross member 54 to a desired transverse position. As the cross member 54 moves transversely, it moves both the upper control arm attachment points in a complimentary manner with respect to the central plane 14 such that the wheels are tilted at an angle with respect to the central plane.

The front cross member positioning means 52 FIG. 4 works in conjunction with the back cross member positioning means 50.

The tilting passenger compartment 6 (best viewed in FIGS. 1,4 and,6) has a fixed mount on a pivot shaft 4, horizontally rotatively mounted to the front pinion 56, and with a back pinion 2 at the opposite transverse end of the respective pivot shaft 4.

The front suspension frame 12 (shown in FIG. 4) also connected in conjunction to the back suspension frame 38, with the body frame 44 horizontally fixed mounted 124, 126 to the respective front suspension frame 12 and the respective back suspension frame 38 at the opposite transverse ends of the respective body frame 128,130.

1. I believe that I may be able to obtain claims directed to a vehicular chassis system as taught by my invention in which a transversely movable cross member is operatively attached to a vehicle frame, with the cross member having at opposite transverse ends thereof left and right upper control arms attachment points, in such a manner that the wheels can be tilted independently from steering the vehicle. I believe that I may also be able to obtain claims to the combination of my basic apparatus as described in the preceding sentence with a steering apparatus that will allow independent control of the tilt and steering functions. I also believe that I can obtain claims directed to the apparatus for independent controlling tilt and steering mounted on the passenger compartment moving with the transversely moveable cross member, as I have done in my mockup.
